(19) United States
(12) Patent Application Publication
(10) Pub. No.: US 2021/0004600 A1
(43) Pub. Date: Jan. 7, 2021

(54) ASSESSING VIDEO STREAM QUALITY

(71) Applicant: Banjo, Inc., South Jordan, UT (US)

(72) Inventors: Joshua J. Newman, Park City, UT (US); Ravi Shankar Kannan, Sandy, UT (US); Spencer R. Moulton, Salt Lake City, UT (US)

(21) Appl. No.: 16/918,993

(22) Filed: Jul. 1, 2020

Related U.S. Application Data
(60) Provisional application No. 62/869,279, filed on Jul. 1, 2019.

(51) Int. Cl. G06K 9/00; H04N 21/234

(52) U.S. Cl. CPC G06K 9/00711; G06K 2009/00738; H04N 21/23418; G06K 9/00456

(57) ABSTRACT

The present invention extends to methods, systems, and computer program products for assessing video stream quality. The quality of a video stream is classified into one of a plurality of quality classifications including a low quality classification and at least one other higher quality classification. A plurality of video quality thresholds are accessed. If any one of the plurality of video quality thresholds is not satisfied, the video stream is classified as low quality. The characteristics of a video stream frame are computed to satisfy each of the plurality of quality thresholds. A video stream technical score is computed from content of the frame based on and subsequent to satisfaction of the plurality of quality thresholds. The video stream is classified as a specified quality, from among the plurality of quality classifications, based on the video stream technical score.

### CROSS-REFERENCE TO RELATED APPLICATIONS

This application claims the benefit of U.S. Provisional Patent Application Ser. No. 62/869,279, entitled “Assessing Video Stream Quality”, filed Jul. 1, 2019, which is incorporated herein in its entirety.

### BACKGROUND

### 1. Background and Relevant Art

Entities (e.g., parents, guardians, friends, relatives, teachers, social workers, first responders, hospitals, delivery services, media outlets, government entities, etc.) may desire to be made aware of relevant events (e.g., fires, accidents, police presence, shootings, etc.) as close as possible to the events' occurrence. However, entities typically are not made aware of an event until after a person observes the event (or the event aftermath) and calls authorities.

In general, techniques that attempt to automate event detection are unreliable. Some techniques have attempted to mine social media data to detect the planning of events and forecast when events might occur. However, events can occur without prior planning and/or may not be detectable using social media data. Further, these techniques are not capable of meaningfully processing available data nor are these techniques capable of differentiating false data (e.g., hoax social media posts)

Other techniques use textual comparisons to compare textual content (e.g., keywords) in a data stream to event templates in a database. If text in a data stream matches keywords in an event template, the data stream is labeled as indicating an event.

Additional techniques use event specific sensors to detect specified types of event. For example, earthquake detectors can be used to detect earthquakes.

It may be that evidence of an event is contained in video. Video may be recorded video, for example, captured at a smart phone camera, that is uploaded in some way for viewing by others. Alternately, video can be live streaming video, for example, streaming from a smart phone camera, a traffic camera, another other public camera, or a private camera.

### BRIEF SUMMARY

Examples extend to methods, systems, and computer program products for assessing video stream quality.

A frame is accessed from a video stream. The quality of the video stream is classified into one of a plurality of quality classifications. The plurality of quality classifications include a low quality classification and at least one other classification indicative of increased quality relative to the low quality classification (e.g., medium quality and/or high quality).

Classifying the quality of the video stream includes accessing a plurality of video quality thresholds. If any one of the plurality of video quality thresholds is not satisfied the video stream is classified as low quality. Classifying the quality of the video stream includes computing that the characteristics of the frame satisfy each of the plurality of quality thresholds. Classifying the quality of the video stream includes computing a video stream technical score from content of the frame based on and subsequent to satisfaction of the plurality of quality thresholds. Classifying the quality of the video stream includes classifying the video stream as a specified quality, from among the plurality of quality classifications, based on the video stream technical score.

A routing module can route the video stream in different ways based the classified video quality. In one aspect, the routing module discards video streams of low quality (as the probability of deriving useful information from the video stream is reduced). In another aspect, the routing module routes the video stream to different neural networks or artificial intelligence modules based on classified video quality. Neural networks or artificial intelligence modules can be tuned to classified video quality.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features and advantages will become more fully apparent from the following description and appended claims, or may be learned by practice as set forth hereinafter.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1A illustrates an example computer architecture that facilitates ingesting signals.

FIG. 1B illustrates an example computer architecture that facilitates detecting events.

FIG. 2 illustrates a flow chart of an example method for normalizing ingested signals.

FIGS. 3A, 3B, and 3C illustrate other example components that can be included in signal ingestion modules.

FIG. 4 illustrates a flow chart of an example method for normalizing an ingested signal including time information, location information, and context information.

FIG. 5 illustrates a flow chart of an example method for normalizing an ingested signal including time information and location information.

FIG. 6 illustrates a flow chart of an example method for normalizing an ingested signal including time information.

FIGS. 7A and 7B illustrates a computer architecture that facilitates assessing video stream quality.

FIG. 8 illustrates a flow chart of an example method for assessing video stream quality.

FIG. 9 illustrates a flow chart of another example method for assessing video stream quality.

FIG. 10 illustrates a flow chart of a further example method for assessing video stream quality.

FIG. 10 depicts an example frame from a traffic camera.

FIG. 11 depicts an example histogram.

### DETAILED DESCRIPTION

Examples extend to methods, systems, and computer program products for assessing video stream quality. Aspects includes assessing video stream quality with use of object reference frames.

One class of signal is an electronic video stream (signal) evidencing a class of event, such as, for example, a fire (structure, wild, forest, etc.), an accident, police presence, a shooting, environmental including weather (fog, snow, rain, reduced visibility conditions, etc.), natural disaster (hurricane, tornado, severe thunderstorms, mudslide, earthquake, etc.), medical emergency, issues with public utilities, etc. Some signals may evidence multiple classes of events. For example, a video including flames and smoke in a forested area may be classified as a fire event and as an environmental event causing reduced visibility.

However, depending on the quality of a video stream, the video stream may be more or less useful when attempting to identify an event. For example, it's less likely that meaningful information can be derived from a lower quality video stream. Further, machine learning pipelines are less inclined to produce meaningful results based on video quality and its frames. As such, assessing quality of a video stream prior to allocating resources for processing the video stream can be useful.

When video stream quality is below a threshold quality (e.g., the video quality is extremely low), resources are not allocated to process the video stream. A notification can be sent for the video stream to be reviewed by human reviewers. If video stream quality is lower, but “good enough” to process, models tailored to lower quality videos streams can be used. Quality of a video stream can also be factored into the confidence of any conclusions reached based on content of the video stream. For example, there may be less confidence associated with detecting the color of a vehicle (e.g., a “blue car”) in a video if video quality is lower.

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: raw signals, social signals, Web signals, streaming signals, normalized signals, events, search terms, geo cell data, geo cell subsets, event notifications, video streams, frames, frame characteristics, image quality thresholds, darkness thresholds, blur thresholds, diagonal resolution thresholds, video stream classifications, video stream qualities, frame (image) technical scores, histograms, score thresholds, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, raw signals, social signals, Web signals, streaming signals, normalized signals, events, search terms, geo cell data, geo cell subsets, event notifications, video streams, frames, frame characteristics, image quality thresholds, darkness thresholds, blur thresholds, diagonal resolution thresholds, video stream classifications, video stream qualities, frame (image) technical scores, histograms, score thresholds, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

In this description and the following claims, a “geo cell” is defined as a piece of “cell” in a grid in any form. In one aspect, geo cells are arranged in a hierarchical structure. Cells of different geometries can be used.

A “geohash” is an example of a “geo cell”.

In this description and the following claims, “geohash” is defined as a geocoding system which encodes a geographic location into a short string of letters and digits. Geohash is a hierarchical spatial data structure which subdivides space into buckets of grid shape (e.g., a square). Geohashes offer properties like arbitrary precision and the possibility of gradually removing characters from the end of the code to reduce its size (and gradually lose precision). As a consequence of the gradual precision degradation, nearby places will often (but not always) present similar prefixes. The longer a shared prefix is, the closer the two places are. geo cells can be used as a unique identifier and to represent point data (e.g., in databases).

In one aspect, a “geohash” is used to refer to a string encoding of an area or point on the Earth. The area or point on the Earth may be represented (among other possible coordinate systems) as a latitude/longitude or Easting/Northing—the choice of which is dependent on the coordinate system chosen to represent an area or point on the Earth. geo cell can refer to an encoding of this area or point, where the geo cell may be a binary string comprised of 0s and 1s corresponding to the area or point, or a string comprised of 0s, 1s, and a ternary character (such as X)—which is used to refer to a don't care character (0 or 1). A geo cell can also be represented as a string encoding of the area or point, for example, one possible encoding is base-32, where every 5 binary characters are encoded as an ASCII character.

Depending on latitude, the size of an area defined at a specified geo cell precision can vary. In one example, as shown in Table 1. the areas defined at various geo cell precisions are approximately:

TABLE 1
Example Areas at Various Geo Cell Precisions

| geo cell Length/Precision | width × height |
|---|---|
| 1 | 5,009.4 km × 4,992.6 km |
| 2 | 1,252.3 km × 624.1 km |
| 3 | 156.5 km × 156 km |
| 4 | 39.1 km × 19.5 km |
| 5 | 4.9 km × 4.9 km |
| 6 | 1.2 km × 609.4 m |
| 7 | 152.9 m × 152.4 m |
| 8 | 38.2 m × 19 m |
| 9 | 4.8 m × 4.8 m |
| 10 | 1.2 m × 59.5 cm |
| 11 | 14.9 cm × 14.9 cm |
| 12 | 3.7 cm × 1.9 cm |

Other geo cell geometries can include hexagonal tiling, triangular tiling, and/or any other suitable geometric shape tiling. For example, the H3 geospatial indexing system can be a multi-precision hexagonal tiling of a sphere (e.g., the Earth) indexed with hierarchical linear indexes.

In another aspect, geo cells are a hierarchical decomposition of a sphere (such as the Earth) into representations of regions or points based a Hilbert curve (e.g., the S2 hierarchy or other hierarchies). Regions/points of the sphere can be projected into a cube and each face of the cube includes a quad-tree where the sphere point is projected into. After that, transformations can be applied and the space discretized. The geo cells are then enumerated on a Hilbert Curve (a space-filling curve that converts multiple dimensions into one dimension and preserves the approximate locality).

Due to the hierarchical nature of geo cells, any signal, event, entity, etc., associated with a geo cell of a specified precision is by default associated with any less precise geo cells that contain the geo cell. For example, if a signal is associated with a geo cell of precision 9, the signal is by default also associated with corresponding geo cells of precisions 1, 2, 3, 4, 5, 6, 7, and 8. Similar mechanisms are applicable to other tiling and geo cell arrangements. For example, S2 has a cell level hierarchy ranging from level zero (85,011,012 km²) to level 30 (between 0.48 cm² to 0.96 cm²).

Signal Ingestion and Normalization

Signal ingestion modules can ingest a variety of raw structured and/or raw unstructured signals on an on going basis and in essentially real-time. Raw signals can include social posts, live broadcasts, traffic camera feeds, other camera feeds (e.g., from other public cameras or from CCTV cameras), listening device feeds, 911 calls, weather data, planned events, IoT device data, crowd sourced traffic and road information, satellite data, air quality sensor data, smart city sensor data, public radio communication (e.g., among first responders and/or dispatchers, between air traffic controllers and pilots), subscription data services, etc.

Raw signals can include different data media types and different data formats, including social signals, Web signals, and streaming signals. Data media types can include audio, video, image, and text. Different formats can include text in XML, text in JavaScript Object Notation (JSON), text in RSS feed, plain text, video stream in Dynamic Adaptive Streaming over HTTP (DASH), video stream in HTTP Live Streaming (HLS), video stream in Real-Time Messaging Protocol (RTMP), other Multipurpose Internet Mail Extensions (MIME) types, etc. Handling different types and formats of data introduces inefficiencies into subsequent event detection processes, including when determining if different signals relate to the same event.

Accordingly, signal ingestion modules can normalize (e.g., prepare or pre-process) raw signals into normalized signals to increase efficiency and effectiveness of subsequent computing activities, such as, event detection, event notification, etc., that utilize the normalized signals. For example, signal ingestion modules can normalize raw signals into normalized signals having a Time, Location, and Context (TLC) dimensions. An event detection infrastructure can use the Time, Location, and Content dimensions to more efficiently and effectively detect events.

A Time (T) dimension can include a time of origin or alternatively a “event time” of a signal. A Location (L) dimension can include a location anywhere across a geographic area, such as, a country (e.g., the United States), a State, a defined area, an impacted area, an area defined by a geo cell, an address, etc.

A Context (C) dimension indicates circumstances surrounding formation/origination of a raw signal in terms that facilitate understanding and assessment of the raw signal. The Context (C) dimension of a raw signal can be derived from express as well as inferred signal features of the raw signal.

Per signal type and signal content, different normalization modules can be used to extract, derive, infer, etc. Time, Location, and Context dimensions from/for a raw signal. For example, one set of normalization modules can be configured to extract/derive/infer Time, Location and Context dimensions from/for social signals. Another set of normalization modules can be configured to extract/derive/infer Time, Location and Context dimensions from/for Web signals. A further set of normalization modules can be configured to extract/derive/infer Time, Location and Context dimensions from/for streaming signals.

Normalization modules for extracting/deriving/inferring Time, Location, and Context dimensions can include text processing modules, NLP modules, image processing modules, video processing modules, etc. The modules can be used to extract/derive/infer data representative of Time, Location, and Context dimensions for a signal. Time, Location, and Context dimensions for a signal can be extracted/derived/inferred from metadata and/or content of the signal.

For example, NLP modules can analyze metadata and content of a sound clip to identify a time, location, and keywords (e.g., fire, shooter, etc.). An acoustic listener can also interpret the meaning of sounds in a sound clip (e.g., a gunshot, vehicle collision, etc.) and convert to relevant context. Live acoustic listeners can determine the distance and direction of a sound. Similarly, image processing modules can analyze metadata and pixels in an image to identify a time, location and keywords (e.g., fire, shooter, etc.). Image processing modules can also interpret the meaning of parts of an image (e.g., a person holding a gun, flames, a store logo, etc.) and convert to relevant context. Other modules can perform similar operations for other types of content including text and video.

Per signal type, each set of normalization modules can differ but may include at least some similar modules or may share some common modules. For example, similar (or the same) image analysis modules can be used to extract named entities from social signal images and public camera feeds. Likewise, similar (or the same) NLP modules can be used to extract named entities from social signal text and web text.

In some aspects, an ingested signal includes sufficient expressly defined time, location, and context information upon ingestion. The expressly defined time, location, and context information is used to determine Time, Location, and Context dimensions for the ingested signal. In other aspects, an ingested signal lacks expressly defined location information or expressly defined location information is insufficient (e.g., lacks precision) upon ingestion. In these other aspects, Location dimension or additional Location dimension can be inferred from features of an ingested signal and/or through references to other data sources. In further aspects, an ingested signal lacks expressly defined context information or expressly defined context information is insufficient (e.g., lacks precision) upon ingestion. In these further aspects, Context dimension or additional Context dimension can be inferred from features of an ingested signal and/or through reference to other data sources.

In further aspects, time information may not be included, or included time information may not be given with high enough precision and Time dimension is inferred. For example, a user may post an image to a social network which had been taken some indeterminate time earlier.

Normalization modules can use named entity recognition and reference to a geo cell database to infer Location dimension. Named entities can be recognized in text, images, video, audio, or sensor data. The recognized named entities can be compared to named entities in geo cell entries. Matches indicate possible signal origination in a geographic area defined by a geo cell.

As such, a normalized signal can include a Time dimension, a Location dimension, a Context dimension (e.g., single source probabilities and probability details), a signal type, a signal source, and content.

A single source probability can be calculated by single source classifiers (e.g., machine learning models, artificial intelligence, neural networks, statistical models, etc.) that consider hundreds, thousands, or even more signal features (dimensions) of a signal. Single source classifiers can be based on binary models and/or multi-class models.

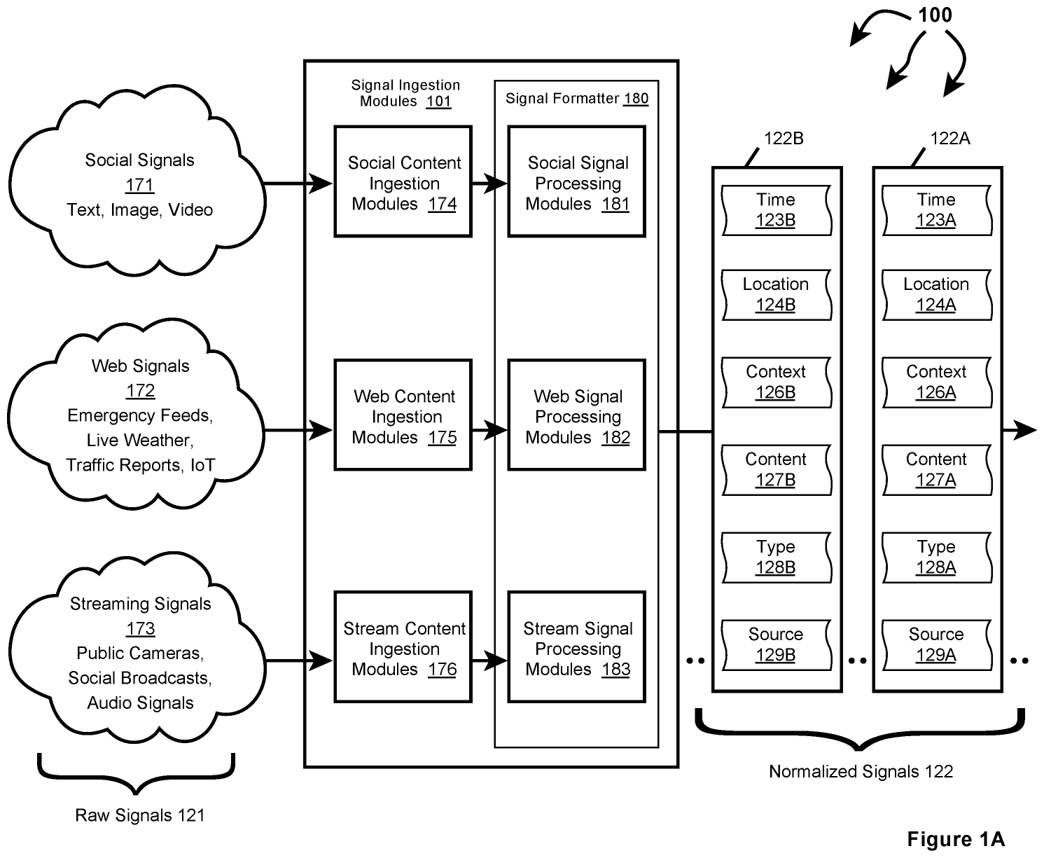

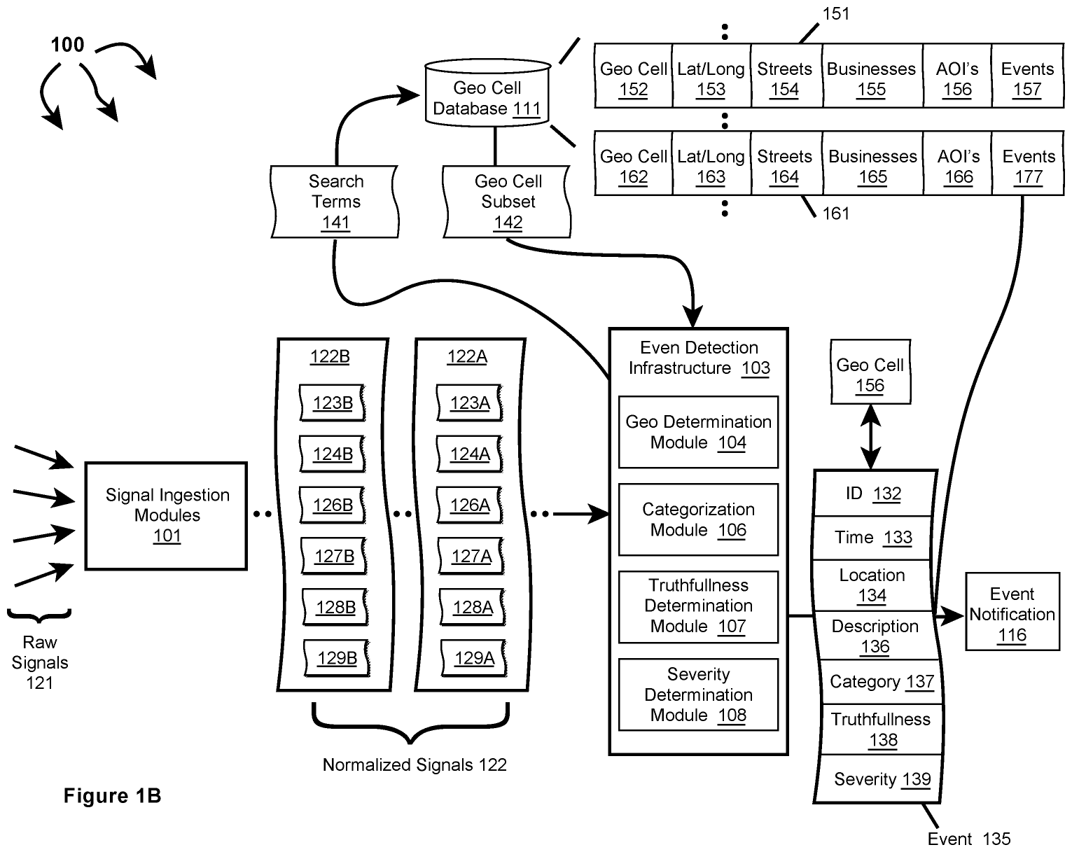

FIG. 1A depicts part of computer architecture 100 that facilitates ingesting and normalizing signals. As depicted, computer architecture 100 includes signal ingestion modules 101, social signals 171, Web signals 172, and streaming signals 173. Signal ingestion modules 101, social signals 171, Web signals 172, and streaming signals 173 can be connected to (or be part of) a network, such as, for example, a system bus, a Local Area Network (“LAN”), a Wide Area Network (“WAN”), and even the Internet. Accordingly, signal ingestion modules 101, social signals 171, Web signals 172, and streaming signals 173 as well as any other connected computer systems and their components can create and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

Signal ingestion module(s) 101 can ingest raw signals 121, including social signals 171, web signals 172, and streaming signals 173, on an on going basis and in essentially real-time. Raw signals 121 can include social posts, recorded videos, streaming videos, traffic camera feeds, other camera feeds, listening device feeds, 911 calls, weather data, planned events, IoT device data, crowd sourced traffic and road information, satellite data, air quality sensor data, smart city sensor data, public radio communication, subscription data service data, etc. As such, potentially thousands, millions or even billions of unique raw signals, each with unique characteristics, are can be ingested and used determine event characteristics, such as, event truthfulness, event severity, event category or categories, etc.

Signal ingestion module(s) 101 include social content ingestion modules 174, web content ingestion modules 176, stream content ingestion modules 176, and signal formatter 180. Signal formatter 180 further includes social signal processing module 181, web signal processing module 182, and stream signal processing modules 183.

For each type of signal, a corresponding ingestion module and signal processing module can interoperate to normalize the signal into a Time, Location, Context (TLC) dimensions. For example, social content ingestion modules 174 and social signal processing module 181 can interoperate to normalize social signals 171 into TLC dimensions. Similarly, web content ingestion modules 176 and web signal processing module 182 can interoperate to normalize web signals 172 into TLC dimensions. Likewise, stream content ingestion modules 176 and stream signal processing modules 183 can interoperate to normalize streaming signals 173 into TLC dimensions.

In one aspect, signal content exceeding specified size requirements (e.g., audio or video) is cached upon ingestion. Signal ingestion modules 101 include a URL or other identifier to the cached content within the context for the signal.

In one aspect, signal formatter 180 includes modules for determining a single source probability as a ratio of signals turning into events based on the following signal properties: (1) event class (e.g., fire, accident, weather, etc.), (2) media type (e.g., text, image, audio, etc.), (3) source (e.g., twitter, traffic camera, first responder radio traffic, etc.), and (4) geo type (e.g., geo cell, region, or non-geo). Probabilities can be stored in a lookup table for different combinations of the signal properties. Features of a signal can be derived and used to query the lookup table. For example, the lookup table can be queried with terms (“accident”, “image”, “twitter”, “region”). The corresponding ratio (probability) can be returned from the table.

In another aspect, signal formatter 180 includes a plurality of single source classifiers (e.g., artificial intelligence, machine learning modules, neural networks, etc.). Each single source classifier can consider hundreds, thousands, or even more signal features (dimensions) of a signal. Signal features of a signal can be derived and submitted to a signal source classifier. The single source classifier can return a probability that a signal indicates a type of event. Single source classifiers can be binary classifiers or multi-source classifiers.

Raw classifier output can be adjusted to more accurately represent a probability that a signal is a “true positive”. For example, 1,000 signals whose raw classifier output is 0.9 may include 80% as true positives. Thus, probability can be adjusted to 0.8 to reflect true probability of the signal being a true positive. “Calibration” can be done in such a way that for any “calibrated score” this score reflects the true probability of a true positive outcome.

Signal ingestion modules 101 can insert one or more single source probabilities and corresponding probability details into a normalized signal to represent a Context (C) dimension. Probability details can indicate a probabilistic model and features used to calculate the probability. In one aspect, a probabilistic model and signal features are contained in a hash field.

Signal ingestion modules 101 can access “transdimensionality” transformations structured and defined in a “TLC” dimensional model. Signal ingestion modules 101 can apply the “transdimensionality” transformations to generic source data in raw signals to re-encode the source data into normalized data having lower dimensionality. Dimensionality reduction can include reducing dimensionality (e.g., hundreds, thousands, or even more signal features (dimensions)) of a raw signal into a normalized signal including a T vector, an L vector, and a C vector. At lower dimensionality, the complexity of measuring “distances” between dimensional vectors across different normalized signals is reduced.

Thus, in general, any received raw signals can be normalized into normalized signals including a Time (T) dimension, a Location (L) dimension, a Context (C) dimension, signal source, signal type, and content. Signal ingestion modules 101 can send normalized signals 122 to event detection infrastructure 103.

For example, signal ingestion modules 101 can send normalized signal 122A, including time 123A, location 124A, context 126A, content 127A, type 128A, and source 129A to event detection infrastructure 103. Similarly, signal ingestion modules 101 can send normalized signal 122B, including time 123B, location 124B, context 126B, content 127B, type 128B, and source 129B to event detection infrastructure 103.

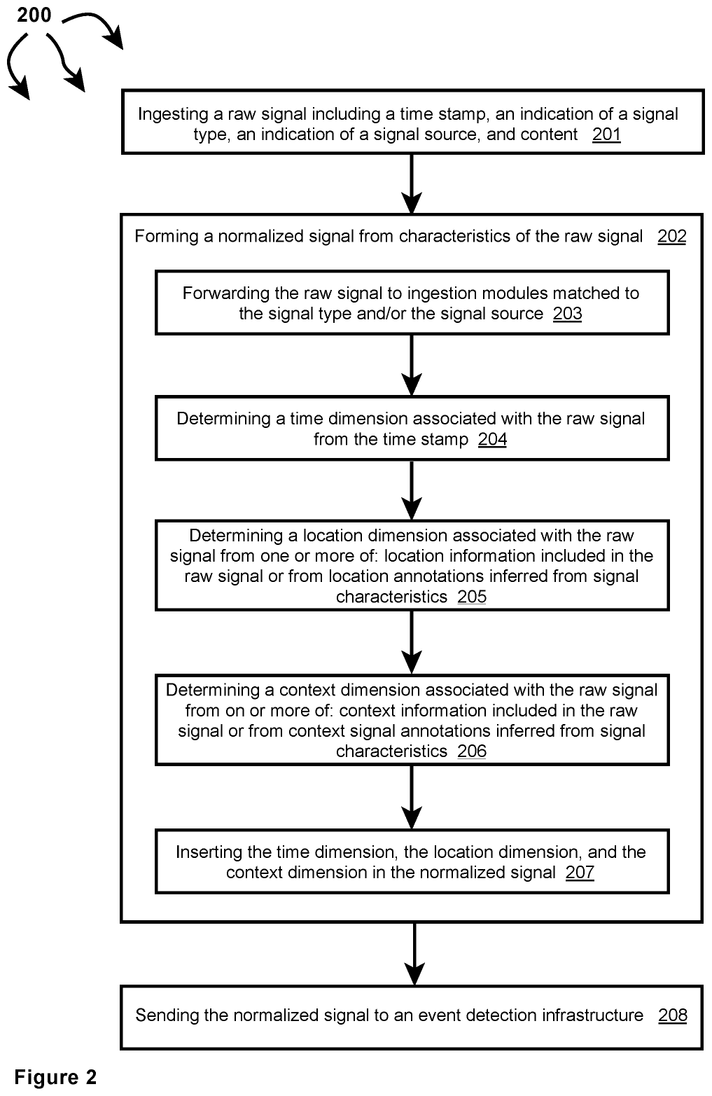

FIG. 2 illustrates a flow chart of an example method 200 for normalizing ingested signals. Method 200 will be described with respect to the components and data in computer architecture 100.

Method 200 includes ingesting a raw signal including a time stamp, an indication of a signal type, an indication of a signal source, and content (201). For example, signal ingestion modules 101 can ingest a raw signal 121 from one of: social signals 171, web signals 172, or streaming signals 173.

Method 200 incudes forming a normalized signal from characteristics of the raw signal (202). For example, signal ingestion modules 101 can form a normalized signal 122A from the ingested raw signal 121.

Forming a normalized signal includes forwarding the raw signal to ingestion modules matched to the signal type and/or the signal source (203). For example, if ingested raw signal 121 is from social signals 171, raw signal 121 can be forwarded to social content ingestion modules 174 and social signal processing modules 181. If ingested raw signal 121 is from web signals 172, raw signal 121 can be forwarded to web content ingestion modules 175 and web signal processing modules 182. If ingested raw signal 121 is from streaming signals 173, raw signal 121 can be forwarded to streaming content ingestion modules 176 and streaming signal processing modules 183.

Forming a normalized signal includes determining a time dimension associated with the raw signal from the time stamp (204). For example, signal ingestion modules 101 can determine time 123A from a time stamp in ingested raw signal 121.

Forming a normalized signal includes determining a location dimension associated with the raw signal from one or more of: location information included in the raw signal or from location annotations inferred from signal characteristics (205). For example, signal ingestion modules 101 can determine location 124A from location information included in raw signal 121 or from location annotations derived from characteristics of raw signal 121 (e.g., signal source, signal type, signal content).

Forming a normalized signal includes determining a context dimension associated with the raw signal from one or more of: context information included in the raw signal or from context signal annotations inferred from signal characteristics (206). For example, signal ingestion modules 101 can determine context 126A from context information included in raw signal 121 or from context annotations derived from characteristics of raw signal 121 (e.g., signal source, signal type, signal content).

Forming a normalized signal includes inserting the time dimension, the location dimension, and the context dimension in the normalized signal (207). For example, signal ingestion modules 101 can insert time 123A, location 124A, and context 126A in normalized signal 122. Method 200 includes sending the normalized signal to an event detection infrastructure (208). For example, signal ingestion modules 101 can send normalized signal 122A to event detection infrastructure 103.

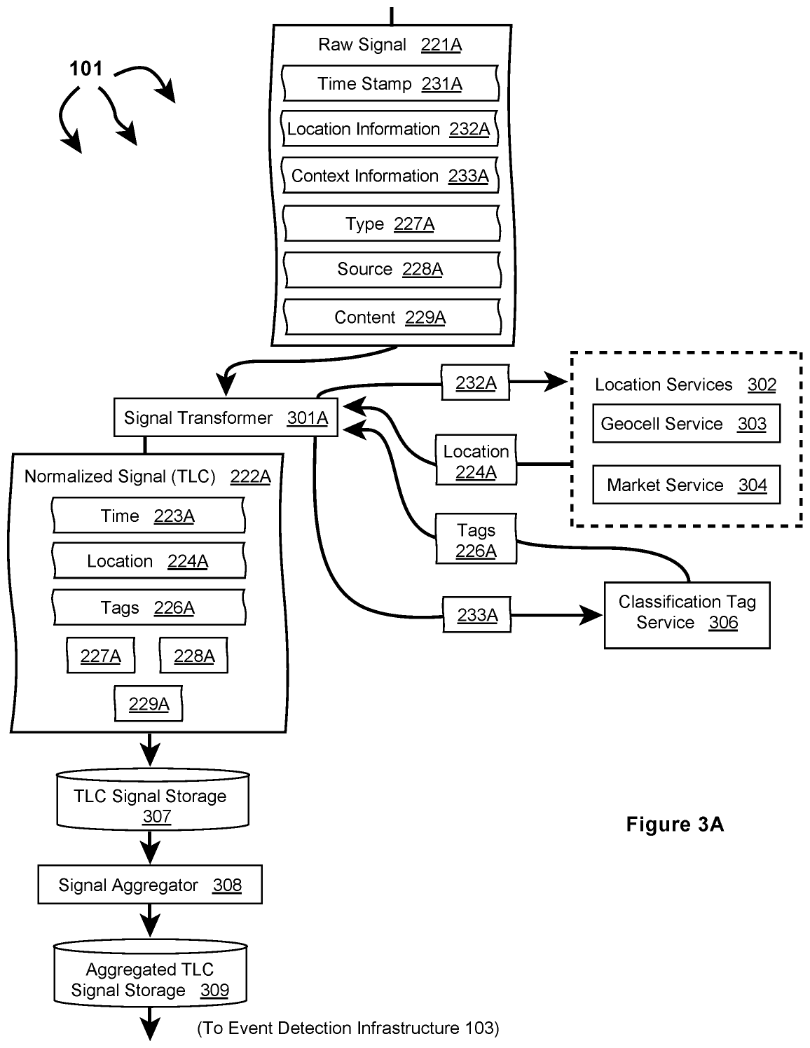

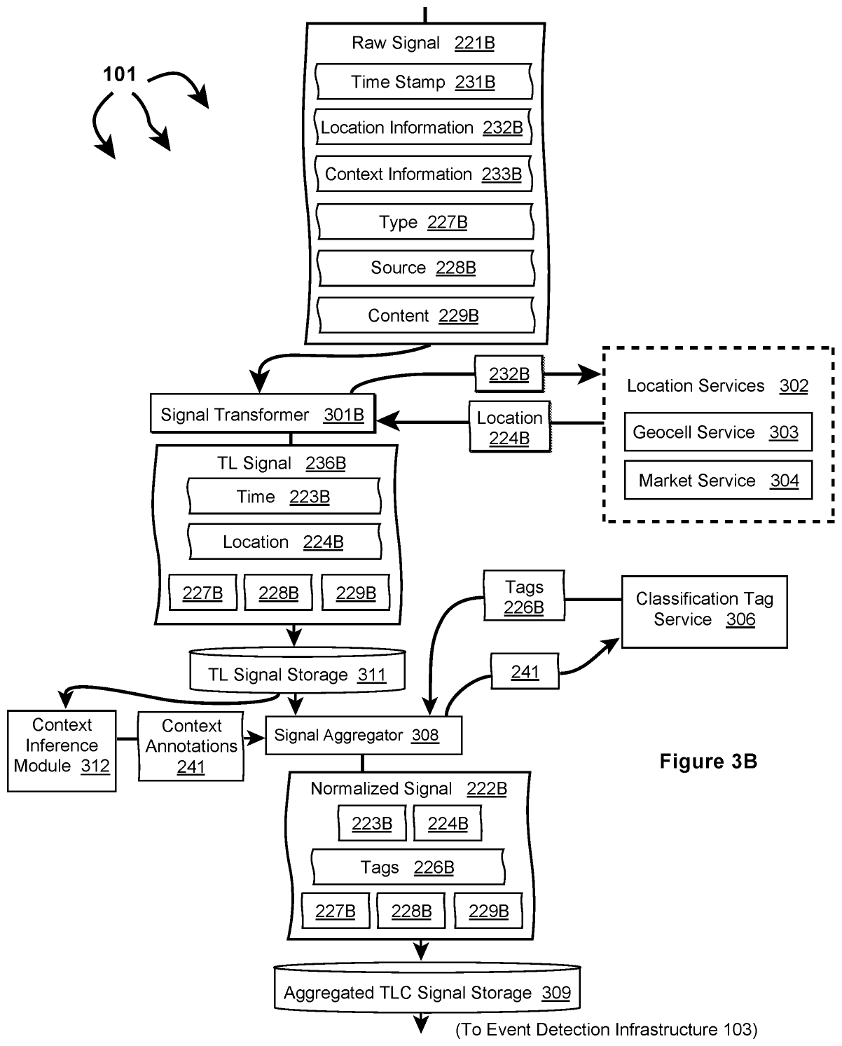

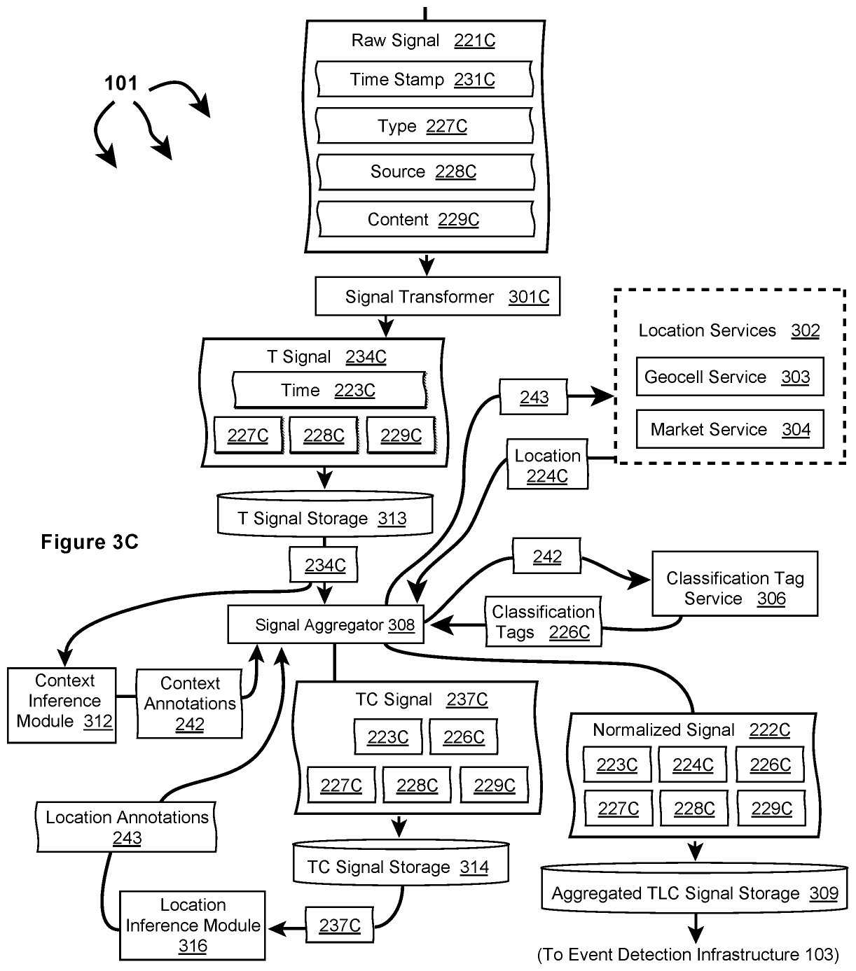

FIGS. 3A, 3B, and 3C depict other example components that can be included in signal ingestion modules 101. Signal ingestion modules 101 can include signal transformers for different types of signals including signal transformer 301A (for TLC signals), signal transformer 301B (for TL signals), and signal transformer 301C (for T signals). In one aspect, a single module combines the functionality of multiple different signal transformers.

Signal ingestion modules 101 can also include location services 302, classification tag service 306, signal aggregator 308, context inference module 312, and location inference module 316. Location services 302, classification tag service 306, signal aggregator 308, context inference module 312, and location inference module 316 or parts thereof can interoperate with and/or be integrated into any of ingestion modules 174, web content ingestion modules 176, stream content ingestion modules 176, social signal processing module 181, web signal processing module 182, and stream signal processing modules 183. Location services 302, classification tag service 306, signal aggregator 308, context inference module 312, and location inference module 316 can interoperate to implement “transdimensionality” transformations to reduce raw signal dimensionality into normalized TLC signals.

Signal ingestion modules 101 can also include storage for signals in different stages of normalization, including TLC signal storage 307, TL signal storage 311, T signal storage 313, TC signal storage 314, and aggregated TLC signal storage 309. In one aspect, data ingestion modules 101 implement a distributed messaging system. Each of signal storage 307, 309, 311, 313, and 314 can be implemented as a message container (e.g., a topic) associated with a type of message.

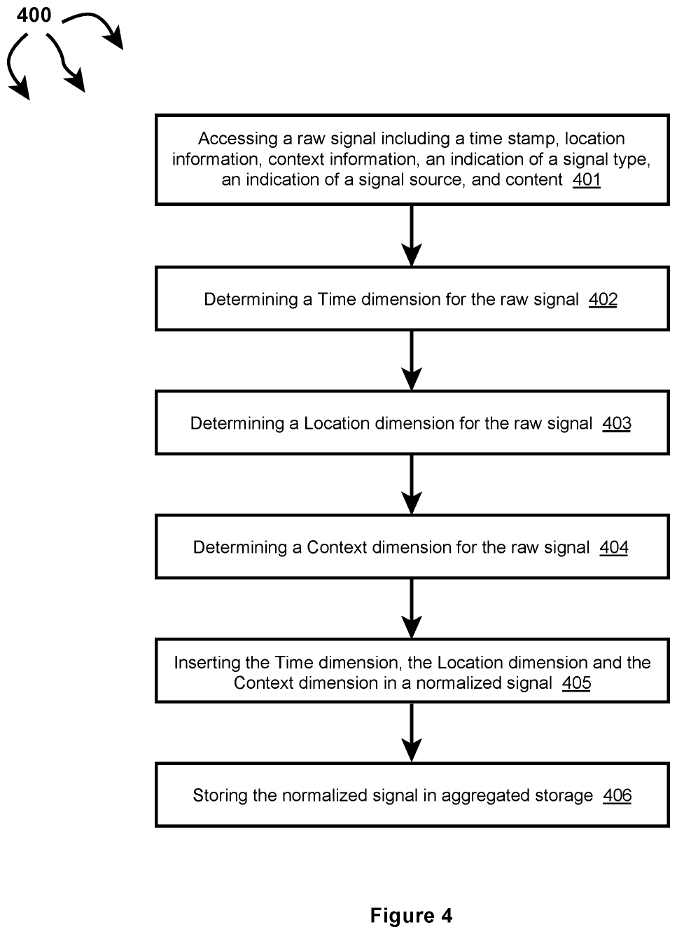

FIG. 4 illustrates a flow chart of an example method 400 for normalizing an ingested signal including time information, location information, and context information. Method 400 will be described with respect to the components and data in FIG. 3A.

Method 400 includes accessing a raw signal including a time stamp, location information, context information, an indication of a signal type, an indication of a signal source, and content (401). For example, signal transformer 301A can access raw signal 221A. Raw signal 221A includes timestamp 231A, location information 232A (e.g., lat/lon, GPS coordinates, etc.), context information 233A (e.g., text expressly indicating a type of event), signal type 227A (e.g., social media, 911 communication, traffic camera feed, etc.), signal source 228A (e.g., Facebook, twitter, Waze, etc.), and signal content 229A (e.g., one or more of: image, video, text, keyword, locale, etc.).

Method 400 includes determining a Time dimension for the raw signal (402). For example, signal transformer 301A can determine time 223A from timestamp 231A.

Method 400 includes determining a Location dimension for the raw signal (403). For example, signal transformer 301A sends location information 232A to location services 302. Geo cell service 303 can identify a geo cell corresponding to location information 232A. Market service 304 can identify a designated market area (DMA) corresponding to location information 232A. Location services 302 can include the identified geo cell and/or DMA in location 224A. Location services 302 return location 224A to signal transformer 301.

Method 400 includes determining a Context dimension for the raw signal (404). For example, signal transformer 301A sends context information 233A to classification tag service 306. Classification tag service 306 identifies one or more classification tags 226A (e.g., fire, police presence, accident, natural disaster, etc.) from context information 233A. Classification tag service 306 returns classification tags 226A to signal transformer 301A.

Method 400 includes inserting the Time dimension, the Location dimension, and the Context dimension in a normalized signal (405). For example, signal transformer 301A can insert time 223A, location 224A, and tags 226A in normalized signal 222A (a TLC signal). Method 400 includes storing the normalized signal in signal storage (406). For example, signal transformer 301A can store normalized signal 222A in TLC signal storage 307. (Although not depicted, timestamp 231A, location information 232A, and context information 233A can also be included (or remain) in normalized signal 222A).

Method 400 includes storing the normalized signal in aggregated storage (406). For example, signal aggregator 308 can aggregate normalized signal 222A along with other normalized signals determined to relate to the same event. In one aspect, signal aggregator 308 forms a sequence of signals related to the same event. Signal aggregator 308 stores the signal sequence, including normalized signal 222A, in aggregated TLC storage 309 and eventually forwards the signal sequence to event detection infrastructure 103.

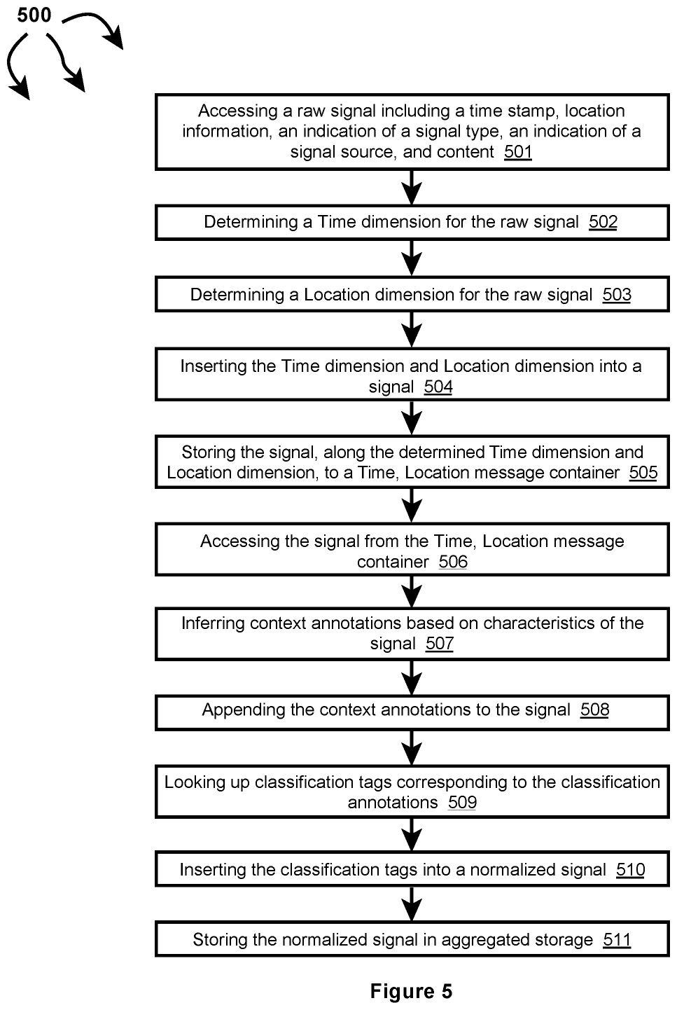

FIG. 5 illustrates a flow chart of an example method 500 for normalizing an ingested signal including time information and location information. Method 500 will be described with respect to the components and data in FIG. 3B.

Method 500 includes accessing a raw signal including a time stamp, location information, an indication of a signal type, an indication of a signal source, and content (501). For example, signal transformer 301B can access raw signal 221B. Raw signal 221B includes timestamp 231B, location information 232B (e.g., lat/lon, GPS coordinates, etc.), signal type 227B (e.g., social media, 911 communication, traffic camera feed, etc.), signal source 228B (e.g., Facebook, twitter, Waze, etc.), and signal content 229B (e.g., one or more of: image, video, audio, text, keyword, locale, etc.).

Method 500 includes determining a Time dimension for the raw signal (502). For example, signal transformer 301B can determine time 223B from timestamp 231B.

Method 500 includes determining a Location dimension for the raw signal (503). For example, signal transformer 301B sends location information 232B to location services 302. Geo cell service 303 can be identify a geo cell corresponding to location information 232B. Market service 304 can identify a designated market area (DMA) corresponding to location information 232B. Location services 302 can include the identified geo cell and/or DMA in location 224B. Location services 302 returns location 224B to signal transformer 301.

Method 500 includes inserting the Time dimension and Location dimension into a signal (504). For example, signal transformer 301B can insert time 223B and location 224B into TL signal 236B. (Although not depicted, timestamp 231B and location information 232B can also be included (or remain) in TL signal 236B). Method 500 includes storing the signal, along with the determined Time dimension and Location dimension, to a Time, Location message container (505). For example, signal transformer 301B can store TL signal 236B to TL signal storage 311. Method 500 includes accessing the signal from the Time, Location message container (506). For example, signal aggregator 308 can access TL signal 236B from TL signal storage 311.

Method 500 includes inferring context annotations based on characteristics of the signal (507). For example, context inference module 312 can access TL signal 236B from TL signal storage 311. Context inference module 312 can infer context annotations 241 from characteristics of TL signal 236B, including one or more of: time 223B, location 224B, type 227B, source 228B, and content 229B. In one aspect, context inference module 312 includes one or more of: NLP modules, audio analysis modules, image analysis modules, video analysis modules, etc. Context inference module 312 can process content 229B in view of time 223B, location 224B, type 227B, source 228B, to infer context annotations 241 (e.g., using machine learning, artificial intelligence, neural networks, machine classifiers, etc.). For example, if content 229B is an image that depicts flames and a fire engine, context inference module 312 can infer that content 229B is related to a fire. Context inference 312 module can return context annotations 241 to signal aggregator 308.

Method 500 includes appending the context annotations to the signal (508). For example, signal aggregator 308 can append context annotations 241 to TL signal 236B. Method 500 includes looking up classification tags corresponding to the classification annotations (509). For example, signal aggregator 308 can send context annotations 241 to classification tag service 306. Classification tag service 306 can identify one or more classification tags 226B (a Context dimension) (e.g., fire, police presence, accident, natural disaster, etc.) from context annotations 241. Classification tag service 306 returns classification tags 226B to signal aggregator 308.

Method 500 includes inserting the classification tags in a normalized signal (510). For example, signal aggregator 308 can insert tags 226B (a Context dimension) into normalized signal 222B (a TLC signal). Method 500 includes storing the normalized signal in aggregated storage (511). For example, signal aggregator 308 can aggregate normalized signal 222B along with other normalized signals determined to relate to the same event. In one aspect, signal aggregator 308 forms a sequence of signals related to the same event. Signal aggregator 308 stores the signal sequence, including normalized signal 222B, in aggregated TLC storage 309 and eventually forwards the signal sequence to event detection infrastructure 103. (Although not depicted, timestamp 231B, location information 232C, and context annotations 241 can also be included (or remain) in normalized signal 222B).

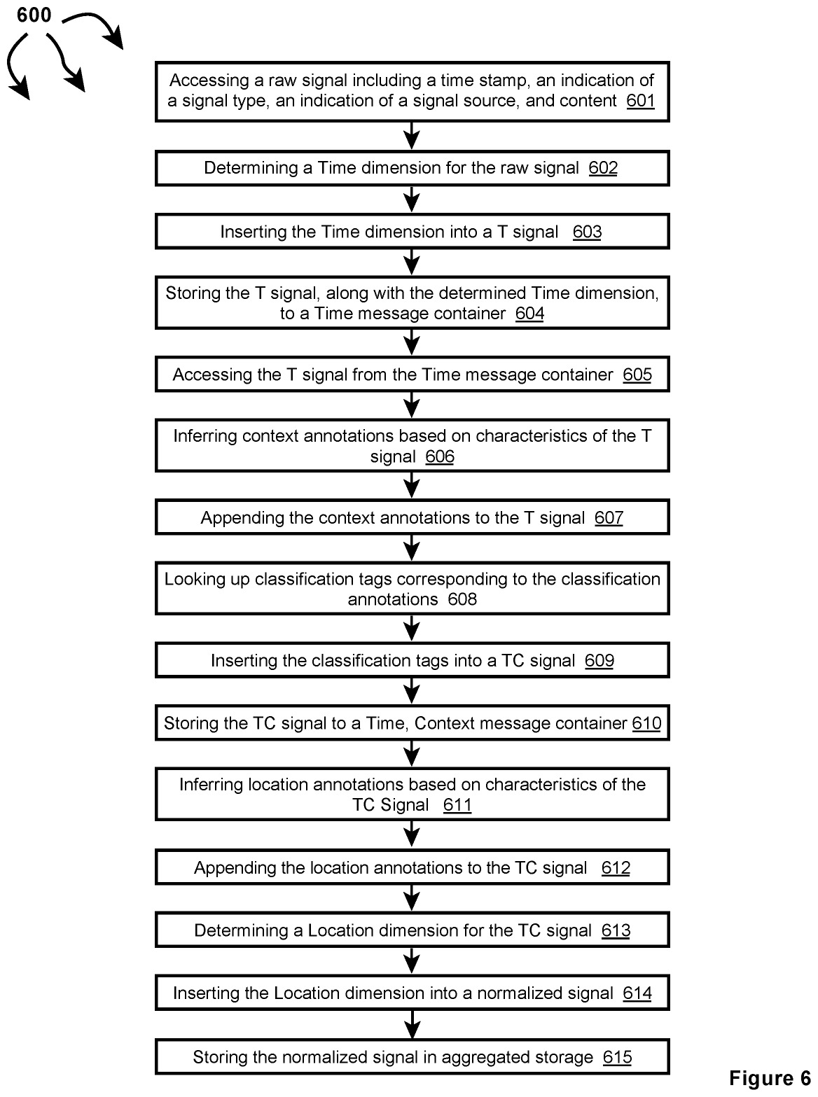

FIG. 6 illustrates a flow chart of an example method 600 for normalizing an ingested signal including time information and location information. Method 600 will be described with respect to the components and data in FIG. 3C.

Method 600 includes accessing a raw signal including a time stamp, an indication of a signal type, an indication of a signal source, and content (601). For example, signal transformer 301C can access raw signal 221C. Raw signal 221C includes timestamp 231C, signal type 227C (e.g., social media, 911 communication, traffic camera feed, etc.), signal source 228C (e.g., Facebook, twitter, Waze, etc.), and signal content 229C (e.g., one or more of: image, video, text, keyword, locale, etc.).

Method 600 includes determining a Time dimension for the raw signal (602). For example, signal transformer 301C can determine time 223C from timestamp 231C. Method 600 includes inserting the Time dimension into a T signal (603). For example, signal transformer 301C can insert time 223C into T signal 234C. (Although not depicted, timestamp 231C can also be included (or remain) in T signal 234C).

Method 600 includes storing the T signal, along with the determined Time dimension, to a Time message container (604). For example, signal transformer 301C can store T signal 236C to T signal storage 313. Method 600 includes accessing the T signal from the Time message container (605). For example, signal aggregator 308 can access T signal 234C from T signal storage 313.

Method 600 includes inferring context annotations based on characteristics of the T signal (606). For example, context inference module 312 can access T signal 234C from T signal storage 313. Context inference module 312 can infer context annotations 242 from characteristics of T signal 234C, including one or more of: time 223C, type 227C, source 228C, and content 229C. As described, context inference module 312 can include one or more of: NLP modules, audio analysis modules, image analysis modules, video analysis modules, etc. Context inference module 312 can process content 229C in view of time 223C, type 227C, source 228C, to infer context annotations 242 (e.g., using machine learning, artificial intelligence, neural networks, machine classifiers, etc.). For example, if content 229C is a video depicting two vehicles colliding on a roadway, context inference module 312 can infer that content 229C is related to an accident. Context inference 312 module can return context annotations 242 to signal aggregator 308.

Method 600 includes appending the context annotations to the T signal (607). For example, signal aggregator 308 can append context annotations 242 to T signal 234C. Method 600 includes looking up classification tags corresponding to the classification annotations (608). For example, signal aggregator 308 can send context annotations 242 to classification tag service 306. Classification tag service 306 can identify one or more classification tags 226C (a Context dimension) (e.g., fire, police presence, accident, natural disaster, etc.) from context annotations 242. Classification tag service 306 returns classification tags 226C to signal aggregator 308.

Method 600 includes inserting the classification tags into a TC signal (609). For example, signal aggregator 308 can insert tags 226C into TC signal 237C. Method 600 includes storing the TC signal to a Time, Context message container (610). For example, signal aggregator 308 can store TC signal 237C in TC signal storage 314. (Although not depicted, timestamp 231C and context annotations 242 can also be included (or remain) in normalized signal 237C).

Method 600 includes inferring location annotations based on characteristics of the TC signal (611). For example, location inference module 316 can access TC signal 237C from TC signal storage 314. Location inference module 316 can include one or more of: NLP modules, audio analysis modules, image analysis modules, video analysis modules, etc. Location inference module 316 can process content 229C in view of time 223C, type 227C, source 228C, and classification tags 226C (and possibly context annotations 242) to infer location annotations 243 (e.g., using machine learning, artificial intelligence, neural networks, machine classifiers, etc.). For example, if content 229C is a video depicting two vehicles colliding on a roadway, the video can include a nearby street sign, business name, etc. Location inference module 316 can infer a location from the street sign, business name, etc. Location inference module 316 can return location annotations 243 to signal aggregator 308.

Method 600 includes appending the location annotations to the TC signal with location annotations (612). For example, signal aggregator 308 can append location annotations 243 to TC signal 237C. Method 600 determining a Location dimension for the TC signal (613). For example, signal aggregator 308 can send location annotations 243 to location services 302. Geo cell service 303 can identify a geo cell corresponding to location annotations 243. Market service 304 can identify a designated market area (DMA) corresponding to location annotations 243. Location services 302 can include the identified geo cell and/or DMA in location 224C. Location services 302 returns location 224C to signal aggregation services 308.

Method 600 includes inserting the Location dimension into a normalized signal (614). For example, signal aggregator 308 can insert location 224C into normalized signal 222C. Method 600 includes storing the normalized signal in aggregated storage (615). For example, signal aggregator 308 can aggregate normalized signal 222C along with other normalized signals determined to relate to the same event. In one aspect, signal aggregator 308 forms a sequence of signals related to the same event. Signal aggregator 308 stores the signal sequence, including normalized signal 222C, in aggregated TLC storage 309 and eventually forwards the signal sequence to event detection infrastructure 103. (Although not depicted, timestamp 231B, context annotations 241, and location annotations 24, can also be included (or remain) in normalized signal 222B).

In another aspect, a Location dimension is determined prior to a Context dimension when a T signal is accessed. A Location dimension (e.g., geo cell and/or DMA) and/or location annotations are used when inferring context annotations.

Accordingly, location services 302 can identify a geo cell and/or DMA for a signal from location information in the signal and/or from inferred location annotations. Similarly, classification tag service 306 can identify classification tags for a signal from context information in the signal and/or from inferred context annotations.

Signal aggregator 308 can concurrently handle a plurality of signals in a plurality of different stages of normalization. For example, signal aggregator 308 can concurrently ingest and/or process a plurality T signals, a plurality of TL signals, a plurality of TC signals, and a plurality of TLC signals. Accordingly, aspects of the invention facilitate acquisition of live, ongoing forms of data into an event detection system with signal aggregator 308 acting as an “air traffic controller” of live data. Signals from multiple sources of data can be aggregated and normalized for a common purpose (e.g., of event detection). Data ingestion, event detection, and event notification can process data through multiple stages of logic with concurrency.

As such, a unified interface can handle incoming signals and content of any kind. The interface can handle live extraction of signals across dimensions of time, location, and context. In some aspects, heuristic processes are used to determine one or more dimensions. Acquired signals can include text and images as well as live-feed binaries, including live media in audio, speech, fast still frames, video streams, etc.

Signal normalization enables the world's live signals to be collected at scale and analyzed for detection and validation of live events happening globally. A data ingestion and event detection pipeline aggregates signals and combines detections of various strengths into truthful events. Thus, normalization increases event detection efficiency facilitating event detection closer to “live time” or at “moment zero”.

Event Detection

Turning back to FIG. 1B, computer architecture 100 also includes components that facilitate detecting events. As depicted, computer architecture 100 includes geo cell database 111 and event notification 116. Geo cell database 111 and event notification 116 can be connected to (or be part of) a network with signal ingestion modules 101 and event detection infrastructure 103. As such, geo cell database 111 and even notification 116 can create and exchange message related data over the network.

As described, in general, on an ongoing basis, concurrently with signal ingestion (and also essentially in real-time), event detection infrastructure 103 detects different categories of (planned and unplanned) events (e.g., fire, police response, mass shooting, traffic accident, natural disaster, storm, active shooter, concerts, protests, etc.) in different locations (e.g., anywhere across a geographic area, such as, the United States, a State, a defined area, an impacted area, an area defined by a geo cell, an address, etc.), at different times from Time, Location, and Context dimensions included in normalized signals. Since, normalized signals are normalized to include Time, Location, and Context dimensions, event detection infrastructure 103 can handle normalized signals in a more uniform manner increasing event detection efficiency and effectiveness.

Event detection infrastructure 103 can also determine an event truthfulness, event severity, and an associated geo cell. In one aspect, a Context dimension in a normalized signal increases the efficiency and effectiveness of determining truthfulness, severity, and an associated geo cell.

Generally, an event truthfulness indicates how likely a detected event is actually an event (vs. a hoax, fake, misinterpreted, etc.). Truthfulness can range from less likely to be true to more likely to be true. In one aspect, truthfulness is represented as a numerical value, such as, for example, from 1 (less truthful) to 10 (more truthful) or as percentage value in a percentage range, such as, for example, from 0% (less truthful) to 100% (more truthful). Other truthfulness representations are also possible. For example, truthfulness can be a dimension or represented by one or more vectors.

Generally, an event severity indicates how severe an event is (e.g., what degree of badness, what degree of damage, etc. is associated with the event). Severity can range from less severe (e.g., a single vehicle accident without injuries) to more severe (e.g., multi vehicle accident with multiple injuries and a possible fatality). As another example, a shooting event can also range from less severe (e.g., one victim without life threatening injuries) to more severe (e.g., multiple injuries and multiple fatalities). In one aspect, severity is represented as a numerical value, such as, for example, from 1 (less severe) to 5 (more severe). Other severity representations are also possible. For example, severity can be a dimension or represented by one or more vectors.

In general, event detection infrastructure 103 can include a geo determination module including modules for processing different kinds of content including location, time, context, text, images, audio, and video into search terms. The geo determination module can query a geo cell database with search terms formulated from normalized signal content. The geo cell database can return any geo cells having matching supplemental information. For example, if a search term includes a street name, a subset of one or more geo cells including the street name in supplemental information can be returned to the event detection infrastructure.

Event detection infrastructure 103 can use the subset of geo cells to determine a geo cell associated with an event location. Events associated with a geo cell can be stored back into an entry for the geo cell in the geo cell database. Thus, over time an historical progression of events within a geo cell can be accumulated.

As such, event detection infrastructure 103 can assign an event ID, an event time, an event location, an event category, an event description, an event truthfulness, and an event severity to each detected event. Detected events can be sent to relevant entities, including to mobile devices, to computer systems, to APIs, to data storage, etc.

Event detection infrastructure 103 detects events from information contained in normalized signals 122. Event detection infrastructure 103 can detect an event from a single normalized signal 122 or from multiple normalized signals 122. In one aspect, event detection infrastructure 103 detects an event based on information contained in one or more normalized signals 122. In another aspect, event detection infrastructure 103 detects a possible event based on information contained in one or more normalized signals 122. Event detection infrastructure 103 then validates the potential event as an event based on information contained in one or more other normalized signals 122.

As depicted, event detection infrastructure 103 includes geo determination module 104, categorization module 106, truthfulness determination module 107, and severity determination module 108.

Generally, geo determination module 104 can include NLP modules, image analysis modules, etc. for identifying location information from a normalized signal. Geo determination module 104 can formulate (e.g., location) search terms 141 by using NLP modules to process audio, using image analysis modules to process images and video frames, etc. Search terms can include street addresses, building names, landmark names, location names, school names, image fingerprints, etc. Event detection infrastructure 103 can use a URL or identifier to access cached content when appropriate.

Generally, categorization module 106 can categorize a detected event into one of a plurality of different categories (e.g., fire, police response, mass shooting, traffic accident, natural disaster, storm, active shooter, concerts, protests, etc.) based on the content of normalized signals used to detect and/or otherwise related to an event.

Generally, truthfulness determination module 107 can determine the truthfulness of a detected event based on one or more of: source, type, age, and content of normalized signals used to detect and/or otherwise related to the event. Some signal types may be inherently more reliable than other signal types. For example, video from a live traffic camera feed may be more reliable than text in a social media post. Some signal sources may be inherently more reliable than others. For example, a social media account of a government agency may be more reliable than a social media account of an individual. The reliability of a signal can decay over time.

Generally, severity determination module 108 can determine the severity of a detected event based on or more of: location, content (e.g., dispatch codes, keywords, etc.), and volume of normalized signals used to detect and/or otherwise related to an event. Events at some locations may be inherently more severe than events at other locations. For example, an event at a hospital is potentially more severe than the same event at an abandoned warehouse. Event category can also be considered when determining severity. For example, an event categorized as a “Shooting” may be inherently more severe than an event categorized as “Police Presence” since a shooting implies that someone has been injured.

Geo cell database 111 includes a plurality of geo cell entries. Each geo cell entry is included in a geo cell defining an area and corresponding supplemental information about things included in the defined area. The corresponding supplemental information can include latitude/longitude, street names in the area defined by and/or beyond the geo cell, businesses in the area defined by the geo cell, other Areas of Interest (AOIs) (e.g., event venues, such as, arenas, stadiums, theaters, concert halls, etc.) in the area defined by the geo cell, image fingerprints derived from images captured in the area defined by the geo cell, and prior events that have occurred in the area defined by the geo cell. For example, geo cell entry 151 includes geo cell 152, lat/lon 153, streets 154, businesses 155, AOIs 156, and prior events 157. Each event in prior events 157 can include a location (e.g., a street address), a time (event occurrence time), an event category, an event truthfulness, an event severity, and an event description. Similarly, geo cell entry 161 includes geo cell 162, lat/lon 163, streets 164, businesses 165, AOIs 166, and prior events 167. Each event in prior events 167 can include a location (e.g., a street address), a time (event occurrence time), an event category, an event truthfulness, an event severity, and an event description.

Other geo cell entries can include the same or different (more or less) supplemental information, for example, depending on infrastructure density in an area. For example, a geo cell entry for an urban area can contain more diverse supplemental information than a geo cell entry for an agricultural area (e.g., in an empty field).

Geo cell database 111 can store geo cell entries in a hierarchical arrangement based on geo cell precision. As such, geo cell information of more precise geo cells is included in the geo cell information for any less precise geo cells that include the more precise geo cell.

Geo determination module 104 can query geo cell database 111 with search terms 141. Geo cell database 111 can identify any geo cells having supplemental information that matches search terms 141. For example, if search terms 141 include a street address and a business name, geo cell database 111 can identify geo cells having the street name and business name in the area defined by the geo cell. Geo cell database 111 can return any identified geo cells to geo determination module 104 in geo cell subset 142.

Geo determination module can use geo cell subset 142 to determine the location of event 135 and/or a geo cell associated with event 135. As depicted, event 135 includes event ID 132, time 133, location 137, description 136, category 137, truthfulness 138, and severity 139.

Event detection infrastructure 103 can also determine that event 135 occurred in an area defined by geo cell 162 (e.g., a geohash having precision of level 7 or level 9). For example, event detection infrastructure 103 can determine that location 134 is in the area defined by geo cell 162. As such, event detection infrastructure 103 can store event 135 in events 167 (i.e., historical events that have occurred in the area defined by geo cell 162).

Event detection infrastructure 103 can also send event 135 to event notification module 116. Event notification module 116 can notify one or more entities about event 135.

Assessing Video Stream Quality

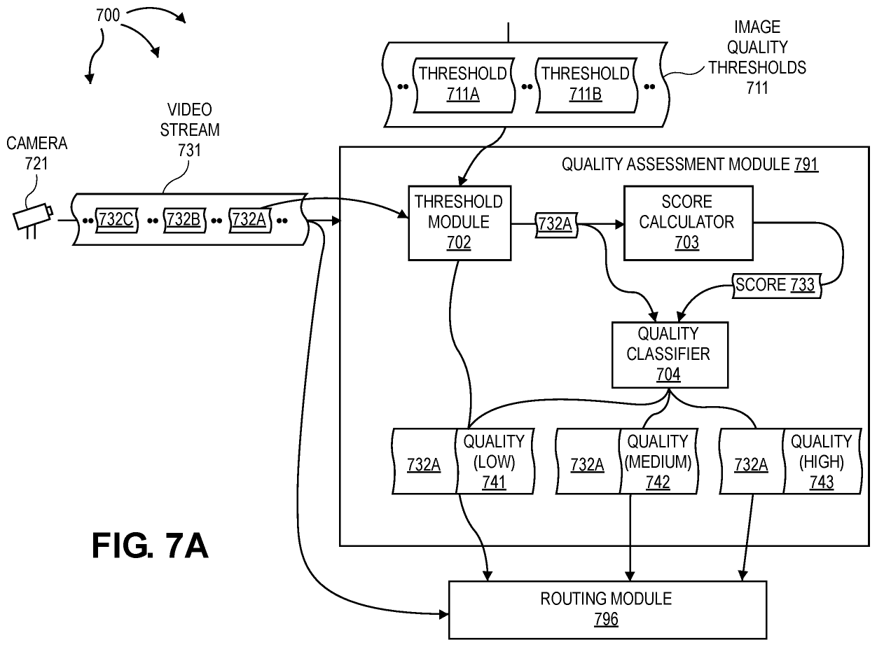

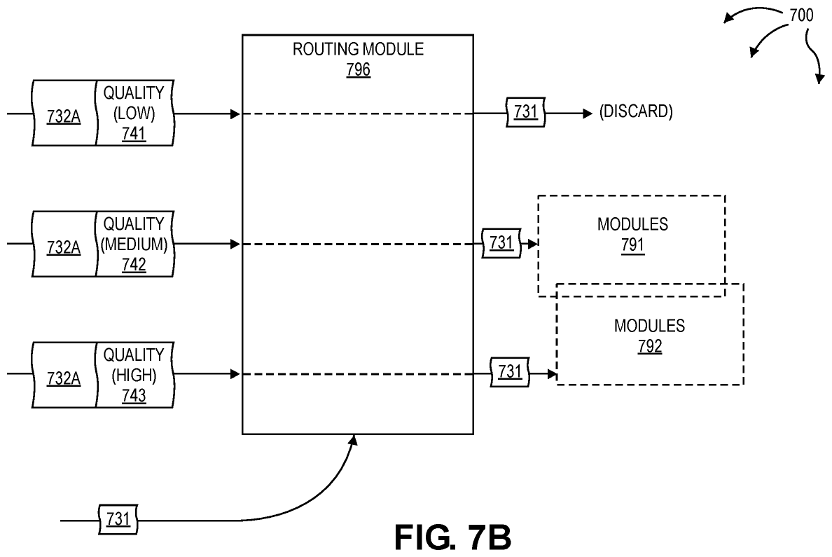

FIG. 7 depicts a computer architecture that facilitates assessing the quality of a video stream without use of object reference frames. As depicted, FIG. 7 includes camera 721 (e.g., a traffic camera or other public camera) and quality assessment module 791. Quality assessment module 791 further includes threshold module 702, score calculator 703, and quality classifier 704.

Image quality thresholds 711 include threshold 711A, threshold 711B, etc. Each image quality threshold can indicate a threshold related to image quality. Thresholds 711 can include thresholds related to the darkness (or lightness) (day vs. night), hue, saturation, blur, resolution (or portions thereof, for example, diagonal resolution), color vs black and white, etc. Resolution thresholds can relate to pixel resolution, spatial resolution, spectral resolution, temporal resolution, radiometric resolution, etc.

Threshold module 702 is configured to receive a frame of a video stream and compare characteristics of the frame to thresholds in image quality thresholds 711. If characteristics of the frame fail to satisfy one or more video quality thresholds 711, the video stream can be classified as a lower (or lowest) quality video. On the other hand, if characteristics of the frame satisfy video quality thresholds 711, the frame can be passed on to score calculator 703.

When a frame (image) is received, threshold module 702 can use various heuristic approaches/algorithms to asses image quality, including computing frame characteristics. For example, threshold module 702 can compute frame (image) blur (e.g., an image blur value) using Cumulative Probability of Blur Detection (CPBD), Laplacian of Gaussian (LoG), etc. Threshold module 702 can determine if an image is more or less likely to be an image captured during the day or night. In one aspect, images are represented in a Hue Saturation Lightness (HSL) color space or Hue Saturation Value (HSV) color space (sometimes referrred to as Hue Saturation Brightness (HSB)). Threshold model 702 can compute a histogram of Luminance values or Value values from an image. Threshold model 702 can estimate frame (image) brightness (e.g., whether an image was captured during the day or at night) from the histogram. For example, threshold model 702 an identify a histogram bin that contains the largest number of Luminance values or Value values (e.g., an image brightness value). Threshold module 702 an also compute a frame (image) diagonal resolution (e.g., an image diagonal resolution value).

Threshold model 702 can compare a computed image blur value to blur threshold. If the computed image blur value does not satisfy the blur threshold, the video stream is classified as lower (or low) quality). Threshold model 702 can compare a computed image brightness value (e.g., a histogram bin number), to a brightness threshold. If the computed image brightness value does not satisfy the brightness threshold, the video stream is classified as lower (or low) quality). Threshold model 702 can compare a computed image diagonal resolution to a resolution threshold. If the computed image diagonal resolution does not satisfy the resolution threshold, the video stream is classified as lower (or low) quality.

When a video stream frame (image) satisfies image quality thresholds 711, threshold module 702 can send the frame (image) to score calculator 703. Score calculator 703 can calculate a technical score associated with the video stream from the characteristics of the frame (image). Score calculator 703 can use any of a variety of approaches to calculate the technical score, including technical and aesthetic weighted approaches trained on various data sets, patch-wise and weighted sub-approaches trained on various data sets, features from mean subtracted contrast normalized (MSCN) coefficients as inputs for generalized Gaussian distributions (GGD) or asymmetrical GGDs, etc. Approaches can be based on various assessment strategies and/or algorithms including but not limited to: Neural Image Assessment (NIMA), Deep (e.g., neural network) Image Quality Assessment (DeepIQA), Blind/Referenceless Image Spatial Quality Evaluator (BRISQUE), etc.

The technical score and frame (image) can be sent to quality classifier 704. Quality classifier 704 can classify the video stream based on the technical score. In one aspect, quality classifier 704 classifies a video stream into one of a plurality of discrete classifications, such as, for example, High, Medium or Low. However, other classification schemes can be used. The other classification schemes can include a fewer or a greater number of different classifications. In one aspect, a classification scheme includes a number range from 1-5, where lower numbers indicate lower quality and higher numbers indicate higher quality or vice versa. In another aspect, a classification scheme includes non-discrete quality classifications, such as, for example, a percentage of a defined maximum quality.

The frame (image) and quality classification can be sent to routing module 796. Routing module 796 can determine how to the route the video stream based on the frame (image) classification. For example, routing module 796 may discard low quality video streams. Routing module 796 can also route a video stream to different processing modules based on frame (image) classification.

As such, routing module 796 can route a video stream in different ways based the classified video quality. In one aspect, routing module 796 discards video streams of low quality (as the probability of deriving useful information from the video stream is reduced). In another aspect, routing module 796 routes the video stream to different neural networks or artificial intelligence modules based on classified video quality. Neural networks or artificial intelligence modules can be tuned to a classified video quality. In one aspect, neural networks and/or artificial intelligence modules are included in signal ingestion modules 101 and/or event detection infrastructure 103.

The probability of deriving useful information from a medium quality video stream is reduced relative to high quality video stream. As such, techniques (e.g., neural networks or artificial intelligence modules) having reduced complexity and/or reduced resource usage can be implemented to attempt to derive useful information from a medium quality video stream. On the other hand, techniques (e.g., neural networks or artificial intelligence modules) having increased complexity and/or increased resource usag can be used to attempt to derive useful information from a high quality video stream. Using increased complexity and/or increased resource usage techniques on a high quality video stream may be more worthwhile, since the probability of deriving useful information is increased relative to a medium quality video stream. Accordingly, algorithm complexity and/or resource usage can be tailored to the probability of deriving useful information from (based on the quality of) a video stream. However, in some aspects, routing module 796 can route video streams of different qualities to one or more of the same neural networks or artificial intelligence modules. That is, some neural networks or artificial intelligence modules may overlap per video stream qualities.

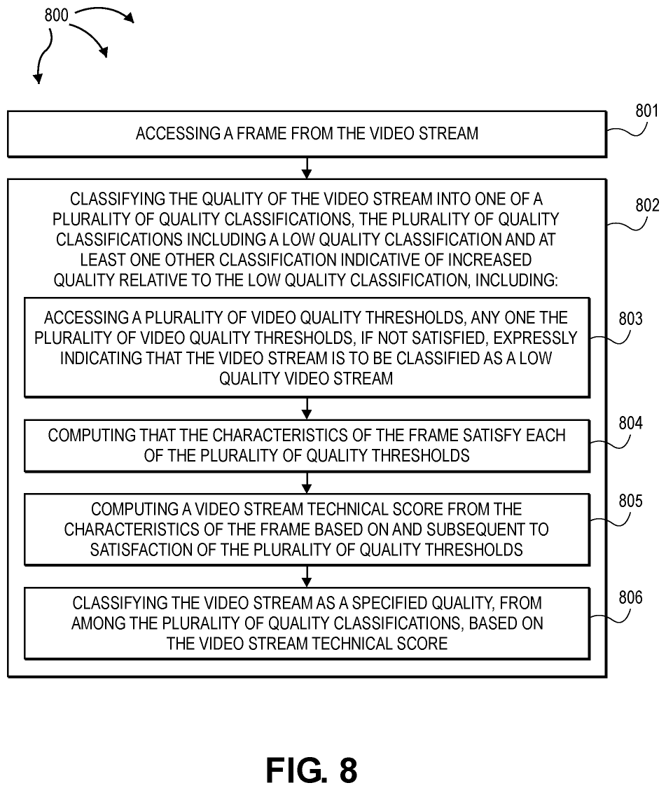

FIG. 8 depicts a flow chart of an example method 800 for assessing the quality of a video stream without use of object reference frames. Method 8 will be described with respect to the components and data depicted into computer architecture 700.

As depicted in computer architecture 700, camera 721 outputs video stream 731, including frames 732A, 732B, 732C, etc. Video stream 731 is streamed to quality assessment module 791 and/or to routing module 796.

Method 800 includes accessing a frame from the video stream (801). For example, threshold module 702 can access frame 732A from video stream 731.

Method 800 includes classifying the quality of the video stream into one of a plurality of quality classifications, the plurality of quality classifications including a low quality classification and at least one other classification indicative of increased quality relative to the low quality classification (802). For example, threshold module 702 can classify video stream 731 as a low quality video stream. Alternately, threshold module 702 can interoperate with score calculator 703 and/or quality classifier 704 to classify video stream 731 as one of: a low quality video stream, a medium quality video stream, or a high quality video stream.

Classifying the quality of the video stream includes accessing a plurality of video quality thresholds, any one the plurality of video quality thresholds, if not satisfied, expressly indicating that the video stream is to be classified as a low quality video stream (803). Classifying the quality of the video stream includes computing that the characteristics of the frame satisfy each of the plurality of quality thresholds (804). For example, threshold module 702 can compute one or more values from the characteristics of frame 732A, such as, for example, a darkness (or lightness) value, a blur value, and a diagonal resolution value. Each computed value can be compared to a corresponding image quality threshold 711.

For example, the darkness (or lightness) value can be compared to a darkness (or lightness) threshold (e.g., threshold 711A). The blur value can be compared to a blur threshold (e.g., threshold 711B). The diagonal resolution value can be compared to a diagonal resolution threshold. If computed values fail to satisfy any relevant thresholds in the quality thresholds 711 (e.g., any of thresholds 711A, 711B, etc.), threshold module 702 can classify video stream 731 as a low quality video stream. Threshold module 702 can associate quality 741 (low) with video stream 731. Threshold module 702 can send frame 732A and quality 741 (low) to routing module 796.

On the other hand, if computed values satisfy relevant thresholds in quality thresholds 711, threshold module 702 can send frame 732A to score calculator 703.

Thus, image quality thresholds 711 can be viewed as “knockout conditions” to quickly classify a video stream (e.g., as low quality). “Knockout conditions” can be used to avoid further processing associated with calculating a technical score and classifying video stream 731 based on the technical score, for example, when there is a reduced possibility of deriving useful information from a video stream.

Classifying the quality of the video stream includes computing a video stream technical score from the characteristics of the frame based on and subsequent to satisfaction of the plurality of quality thresholds (805). For example, score calculator 703 can calculate score 733 from characteristics of frame 732A. Score calculator 703 can send score 733 to quality classifier 704. Classifying the quality of the video stream includes classifying the video stream as a specified quality, from among the plurality of quality classifications, based on the video stream technical score (806). For example, quality classifier 704 can classifier video stream 731 as low, medium or high based on score 733. Quality classifier 704 can associate the specified quality with frame 732A.

Quality classifier 704 can send frame 732A along with the specified quality to routing module 796. For example, if quality classifier 704 classifies video stream 731 as a low quality video stream, quality classifier 704 can send frame 732A along with quality 741 (low) to routing module 796. If quality classifier 704 classifies video stream 731 as a medium quality video stream, quality classifier 704 can send frame 732A along with quality 742 (medium) to routing module 796. If quality classifier 704 classifies video stream 731 as a high quality video stream, quality classifier 704 can send frame 732A along with quality 743 (high) to routing module 796.

Routing module 796 can determine how and/or where to route video stream 731 for further processing based on quality classification. For example, routing module 196 may discard video stream 731 based video stream 731 being of quality 741 (or not being classified at all). Routing module 796 may route video stream 731 to different modules depending on video stream 731 being of quality 742 or being of quality 743.

For example, turning to FIG. 7B, when frame 732A is classified as quality 741 (low), routing module 796 can discard video stream 731.

When frame 732A is classified as quality 742 (medium), routing module 796 can route video stream 731 to modules 791. Modules 791 can include any of: neural networks, artificial intelligence algorithms, or other algorithms tailored to attempt to derive information from medium quality video streams. Modules 791 may be included in signal ingestion modules 101 and/or event detection infrastructure 103.

When frame 732A is classified as quality 743 (high), routing module 796 can route video stream 731 to modules 792. Modules 792 can include any of: neural networks, artificial intelligence algorithms, or other algorithms tailored to attempt to derive information from high quality video streams. Modules 792 may be included in signal ingestion modules 101 and/or event detection infrastructure 103. As depicted, modules 791 and modules 792 may at least partially overlap.

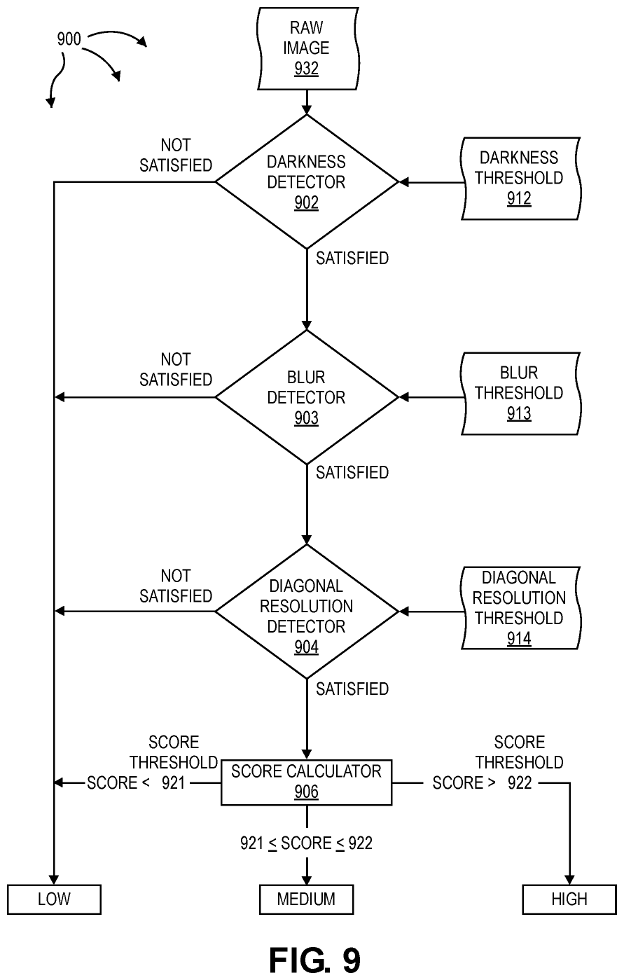

FIG. 9 illustrates another example 900 of classifying a video stream frame (image). Raw image 932 can be received at darkness detector 902 (e.g., included in threshold module 702). Darkness detector 902 can compare the darkness of raw image 932 to darkness threshold 912 (e.g., included in image quality thresholds 711). If the darkness of raw image 932 does not satisfy darkness threshold 912 (e.g., the raw image 932 is to dark), raw image 932 (and an associated video stream) is classified as low quality. If the darkness of raw image 932 does satisfy darkness threshold 912, processing moves to blur detector 903.

Blur detector 903 (e.g., included in threshold module 702) can compare the blurriness of raw image 932 to blur threshold 913 (e.g., included in image quality thresholds 711). If the blurriness of raw image 932 does not satisfy blur threshold 913 (e.g., the raw image 932 is to blurry), raw image 932 (and an associated video stream) is classified as low quality. If the blurriness of raw image 932 does satisfy blur threshold 913, processing moves to diagonal resolution detector 904.

Diagonal resolution detector 904 (e.g., included in threshold module 702) can compare the diagonal resolution of raw image 932 to diagonal resolution threshold 914 (e.g., included in image quality thresholds 711). If the diagonal resolution of raw image 932 does not satisfy diagonal resolution threshold 914 (e.g., the diagonal resolution of raw image 932 is to low), raw image 932 (and an associated video stream) is classified as low quality. If the diagonal resolution of raw image 932 does satisfy diagonal resolution threshold 914, processing moves to score calculator 906.

Score calculator 906 (e.g., included in score calculator 703) can compute a technical score for raw image 932. If the computed technical score is less than score threshold 921, raw image 932 (and an associated video stream) is classified as low quality. If the computed technical score is higher than threshold 922, raw image 932 (and an associated video stream) is classified as high quality. If the computed technical score is greater than or equal to score threshold 921 and less than or equal to score threshold 922, raw image 932 (and an associated video stream) is classified as medium quality.

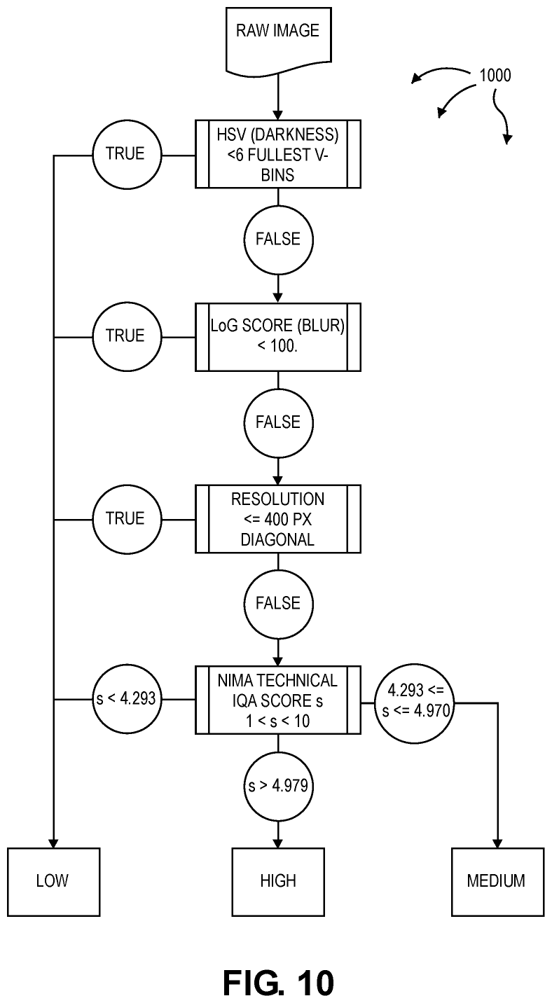

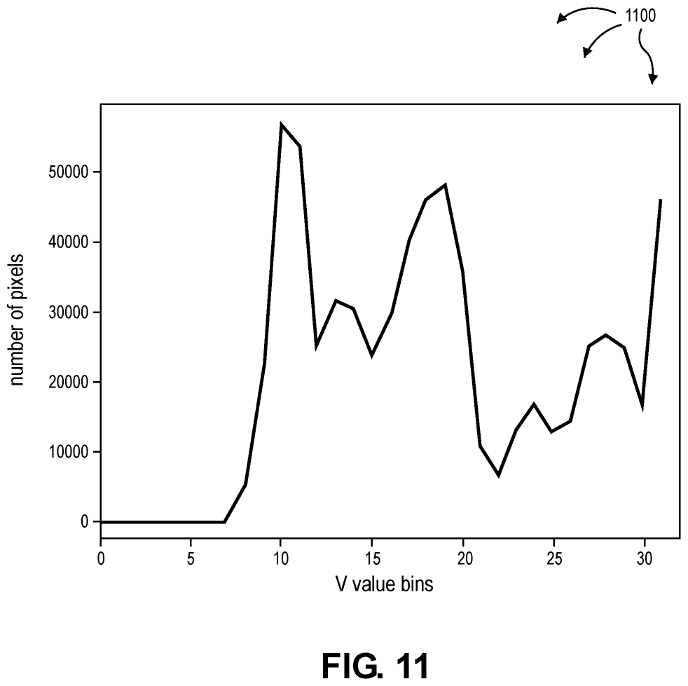

FIG. 10 illustrates another example 1000 of classifying a video stream frame (image). In one aspect, images are considered in an HSV color space. A histogram of Value values per pixel can be computed. An example histogram 1100 is depicted in FIG. 11. V values in an image can range from 0 to 256 (with lower numbers representing less light and larger numbers representing more light). For more efficient visualization, the range of 0 to 256 can be compressed into a reduced number of bins, for example, 32 bins.

The bin number containing the largest number of pixels (i.e., the fullest bin) is compared to a threshold bin value. If the bin number is less than the threshold bin value (e.g., 6), the raw image is considered insufficiently illuminated. The raw image is classified as “low”. On the other hand, if the bin number is greater than (or equal to) the threshold bin value, the raw image is considered to be sufficiently illuminated. Processing proceeds to blur computations. In histogram 500, the fullest bin is bin 10. 10 is greater than (or equal to) 6. As such, the raw image is considered to be sufficiently illuminated.

In other aspects, more complex heuristics can consider additional bins when determining image illumination.

Blur can be computed as a LoG score. If the LoG score is less than a threshold (e.g., less than 100), the raw image is classified as “low”. On the other hand, if the LoG score is greater than (or equal) the threshold, processing proceeds to resolution computations.

A diagonal resolution in pixels of the raw image can be computed. If the diagonal resolution is less than or equal to a specified number of pixels (e.g., 400 pixels), the raw image is classified as “low”. On the other hand, if the diagonal resolution is greater than the specified number of pixels, processing proceeds to technical score calculation.

A Neural Image Assessment (“NIMA”) technical Image Quality Assessment (“IQA”) score between 1 and 10 can be computed for the raw image. If the technical score is less than 4.293 the raw image is classified as “low”. If the technical score is greater than or equal to 4.293 and less than or equal to 4.979, the raw image is classified as medium. If the technical score is greater than 4.979, the image is classified as high.

Thus, aesthetic image assessments, for example, capturing semantic level characteristics associated with emotions and/or beauty in images can be performed and/or considered. Aesthetic image assessments (e.g., aesthetic visual analysis (AVA)) can be used when assessing image quality. In one aspect, technical scores are considered in combination with aesthetic image assessments when assessing image quality.

The components in any of computer architecture 700, method 900, or method 1000 can be connected to (or be part of) a network, such as, for example, a system bus, a Local Area Network (“LAN”), a Wide Area Network (“WAN”), and even the Internet, along with components of computer architecture 100. Accordingly, the components as well as any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network. As such, components any of computer architecture 700, method 900, or method 1000 interoperate with components in computer architecture 100 to implement aspects of the invention.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method comprising:
accessing a frame from a video stream;
classifying the quality of the video stream into one of a plurality of quality classifications, the plurality of quality classifications including a low quality classification and at least one other classification indicative of increased quality relative to the low quality classification, including:
accessing plurality of video quality thresholds, any one the plurality of video quality thresholds, if not satisfied, expressly indicating that the video stream is to be classified as a low quality video stream;
computing that the characteristics of the frame satisfy each of the plurality of quality thresholds;
computing a video stream technical score from content of the frame based on and subsequent to satisfaction of the plurality of quality thresholds; and
classifying the video stream as a specified quality, from among the plurality of quality classifications, based on the video stream technical score.

2. The method of claim 1, wherein classifying the video stream as a specified quality comprises classifying the video stream as a low quality video based on the video stream technical score.

3. The method of claim 1, wherein classifying the video stream as a specified quality comprises classifying the video stream as one of the at least one other classifications based on the video stream technical score.

4. The method of claim 1, wherein computing that the characteristics of the frame satisfy each of the plurality of quality thresholds comprises:
computing a darkness value from content of the frame; and
determining the darkness value satisfies a darkness threshold.

5. The method of claim 4, wherein computing a darkness value from content of the frame comprises:
accessing a V value for each pixel in the image;
creating a histogram including a plurality of bins from the distribution of accessed V values;
selecting a bin, from among the plurality of bins included in the histogram, containing the largest number of pixels; and
assigning the value of the selected bin to the darkness value.

6. The method of claim 1, wherein computing that the characteristics of the frame satisfy each of the plurality of quality thresholds comprises:
computing a blur value from content of the frame; and
determining the blur value satisfies a blur threshold.

7. The method of claim 1, wherein computing that the characteristics of the frame satisfy each of the plurality of quality thresholds comprises:
computing a diagonal resolution value from content of the frame; and
determining the diagonal resolution value satisfies a diagonal resolution threshold.

8. The method of claim 1, wherein computing a video stream technical score comprises computing a video stream technical score from content of the frame based on satisfaction of: a darkness threshold, a blur threshold, and a diagonal resolution threshold.

9. The method of claim 1, further comprising performing an aesthetic image assessment of the frame; and
wherein classifying the video stream as a specified quality comprises classifying the video stream as a specified quality based on the video stream technical score and the aesthetic image assessment.

10. The method of claim 1, wherein assigning a video stream quality comprises assigning a video stream quality selected from among: low quality, medium quality, and high quality, wherein low quality is assigned to video stream technical scores below a first video stream technical score threshold, wherein high quality is assigned to video stream technical scores above a second video stream technical score threshold, and wherein medium quality is assigned to video stream technical scores that are both: above or equal to the first video stream technical score threshold and below or equal to the second video stream technical score threshold.

11. A system comprising:
a processor; and
system memory coupled to the processor and storing instructions configured to cause the processor to:
access a frame from a video stream;
classify the quality of the video stream into one of a plurality of quality classifications, the plurality of quality classifications including a low quality classification and at least one other classification indicative of increased quality relative to the low quality classification, including:
access plurality of video quality thresholds, any one the plurality of video quality thresholds, if not satisfied, expressly indicating that the video stream is to be classified as a low quality video stream;
compute that the characteristics of the frame satisfy each of the plurality of quality thresholds;
compute a video stream technical score from content of the frame based on and subsequent to satisfaction of the plurality of quality thresholds; and
classify the video stream as a specified quality, from among the plurality of quality classifications, based on the video stream technical score.

12. The system of claim 11, wherein instructions configured to classify the video stream as a specified quality comprise instructions configured to classify the video stream as a low quality video based on the video stream technical score.

13. The system of claim 1, wherein instructions configured to classify the video stream as a specified quality comprise instructions configured to classify the video stream as one of the at least one other classifications based on the video stream technical score.

14. The system of claim 1, wherein instructions configured to compute that the characteristics of the frame satisfy each of the plurality of quality thresholds comprise instructions configured to:
compute a darkness value from content of the frame; and
determine the darkness value satisfies a darkness threshold.

15. The system of claim 14, wherein instructions configured to computing a darkness value from content of the frame comprise instructions configured to:
accessing a V value for each pixel in the image;
creating a histogram including a plurality of bins from the distribution of accessed V values;
selecting a bin, from among the plurality of bins included in the histogram, containing the largest number of pixels; and
assigning the value of the selected bin to the darkness value.

16. The system of claim 11, wherein instructions configured to compute that the characteristics of the frame satisfy each of the plurality of quality thresholds comprise instructions configured to:
compute a blur value from content of the frame; and
determine the blur value satisfies a blur threshold.

17. The system of claim 11, wherein instructions configured to compute that the characteristics of the frame satisfy each of the plurality of quality thresholds comprise instructions configured to:
compute a diagonal resolution value from content of the frame; and
determine the diagonal resolution value satisfies a diagonal resolution threshold.

18. The system of claim 1, wherein instructions configured to compute a video stream technical score comprise instructions configured to computing a video stream technical score from content of the frame in response to satisfaction of: a darkness threshold, a blur threshold, and a diagonal resolution threshold.

19. The system of claim 1, further comprising instructions configured to perform an aesthetic image assessment of the frame; and
wherein instructions configured to classify the video stream as a specified quality comprise instructions configured to classifying the video stream as a specified quality based on both the video stream technical score and the aesthetic image assessment.

20. The system of claim 1, wherein instructions configured to assign a video stream quality comprise instructions configured to assign a video stream quality selected from among: low quality, medium quality, and high quality, wherein low quality is assigned to video stream technical scores below a first video stream technical score threshold, wherein high quality is assigned to video stream technical scores above a second video stream technical score threshold, and wherein medium quality is assigned to video stream technical scores that are both: above or equal to the first video stream technical score threshold and below or equal to the second video stream technical score threshold.
